(19) United States
(12) Patent Application Publication
(10) Pub. No.: US 2009/0034893 A1
(43) Pub. Date: Feb. 5, 2009

(54) Rolled Plain Bearing Bush

(76) Inventor: Karl Back, Diehlheim (DE)

Correspondence Address: DREISS, FUHLENDORF, STEIMLE & BECKER, POSTFACH 10 37 62, D-70032 STUTTGART, DE

(21) Appl. No.: 12/223,699

(22) PCT Filed: May 24, 2007
(86) PCT No.: PCT/EP2007/004617

§ 371 Date: Aug. 7, 2008

(30) Foreign Application Priority Data
Jun. 20, 2006 (DE) 10 2006 028 272.8

(51) Int. Cl. F16C 19/50; B21D 53/10

(52) U.S. Cl. 384/476; 29/898.054

(57) ABSTRACT

The invention relates to a rolled plain bearing bush (2) having a plurality of grooves (8) which are provided on its outer periphery (4) and run in the peripheral direction, which grooves (8) are of wedge-shaped or V-shaped design, so that, in the course of the calibration of the plain bearing bush (2) by passing through a mandrel while the outer periphery is fixedly held, they can receive a material displacement by virtue of being at least partially closed or narrowed.

The invention concerns a “rolled” plain bearing bush, i.e. a plain bearing bush comprising a joint, which is calibrated by passing a mandrel through it, while the outer periphery is fixedly held.

Bushes of a wall thickness of approximately 0.75 to 3 mm, in particular 0.75 to 1.5 mm, are usually produced with a calibration allowance of approximately 10 to 30 μm, in particular approximately 20 μm, which is also within the order of magnitude of the band thickness tolerance of the sheet material that is used. This means that the wall thickness of the sheet material is overdimensioned by this order of magnitude or, in other words, the inner diameter of the sheet material section, formed as a bush, has an undersize of this order of magnitude. Since for calibration processes of the above-described type, the outer periphery is precisely predetermined and thus fixed in the calibration tool (calibration template), the material that is displaced due to passage of the mandrel is displaced in the direction of the width, i.e. in the axial direction, of the rolled plain bearing bush. In consequence thereof, one obtains an undefined bush width which may have to be corrected by another expensive operation, in particular, a machining operation.

U.S. Pat. No. 2,905,511 discloses a half bearing that covers an angle of 180° and has a plurality of regular or irregular depressions on its outer periphery, wherein one embodiment comprises grooves that extend in the peripheral direction. The depressions are used to improve the acceptance and compensation of the extreme loads that occur during operation of the half bearing. Situations like this result from alignment errors of the supported shaft. Half bearings do not have the calibration problem caused by passage of a mandrel. Half bearings are, at most, finished by machining.

It is the underlying purpose of the present invention to solve the above-mentioned problem of calibrating rolled plain bearing bushes.

This object is achieved in accordance with the invention by a plain bearing bush comprising a plurality of grooves that are provided on its outer periphery, extend in the peripheral direction, and have a wedge-shaped or V-shaped design, so that they can accept material that has been displaced during calibration of the plain bearing bush due to passage of a mandrel thereby fixedly holding the outer periphery in that they are at least partially closed or narrowed.

Each inventive macroscopic groove thereby extends in one plane that extends perpendicularly to the direction of tensile force of the mandrel. The grooves preferably extend exactly in the peripheral direction, i.e. concentrically to the longitudinal central axis of the plain bearing bush. The grooves form an effective reservoir for accepting material deformations in the course of calibration, whereby material flow beyond the predetermined bush width can be reduced or even prevented. The grooves are thereby at least partially closed or at least narrowed. “Passing the mandrel through” means moving the mandrel and/or the bush relative to each other in the axial direction.

It has turned out to be particularly suitable for the grooves to taper to the inside and have a wedge-shaped or V-shaped design, since in this case, they exhibit a smaller resistance to material displacement, i.e. close more easily in case of material displacement due to deformation, which is desired in accordance with the invention.

The flanks of the grooves are advantageously designed in such a fashion that they form an angle of 20° to 40°, in particular 20° to 25°, with respect to the radial plane. In correspondence therewith, the overall opening angle of the grooves has double the size (when the flanks have the same angles of inclination).

The grooves advantageously have a depth of 0.05 to 0.5 mm with conventional wall thicknesses of the sheet material of approximately 0.75 to 3 mm. In an advantageous fashion, the grooves have a depth of 5 to 25% of the wall thickness of the bush.

It has also turned out to be advantageous for the grooves to have an axial separation of 1 to 3 mm, in particular 1 to 2 mm, from each other.

The invention also concerns a method for producing and calibrating a rolled plain bearing bush comprising the features of claim 7.

With respect to production, the grooves are advantageously embossed through rolling a tool on the sheet material band supplied in the machine direction. Introduction of the grooves through machining is, in principle, also feasible. This is, however, more demanding in view of production technology, and surprisingly offers no advantages. It has turned out that embossed grooves are equally suited as a reservoir for accepting displaced material.

As mentioned above, the grooves preferably have a tapering, in particular of a wedge-shaped or V-shaped design.

In one particularly advantageous embodiment of the invention, the inventive macroscopic grooves are provided as a reservoir for accepting deformed material, since in addition to the outer periphery, the bush width can also be fixedly held in the tool by supporting flanks during calibration, since the overall displaced material is guided into the grooves during passage of the mandrel. A free-falling rolled plain bearing bush that is ready to use is thereby obtained by one single calibration step without the need for any substantial further processing.

Further features, details and advantages of the invention can be extracted from the enclosed claims, the drawing, and the following description of a preferred embodiment of the inventive plain bearing bush. In the drawing:

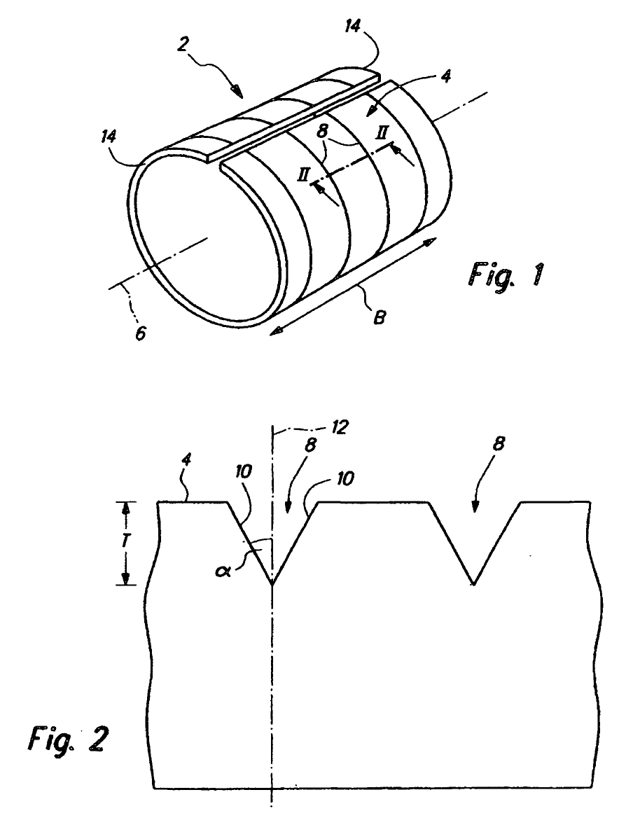

FIG. 1 shows a perspective view of an inventive plain bearing bush (not drawn to scale); and

FIG. 2 shows a sectional view with a sectional plane II-II of FIG. 1 (not drawn to scale).

The figures show the design of an inventive “rolled” plain bearing bush 2 with a resulting joint of the bush that is closed when the bush is pressed in. The plain bearing bushes of the type of interest are preferably plain bearing bushes that are produced from a metallic plain bearing composite material. The metallic plain bearing composite material comprises in most cases a carrier or a back of steel, bronze, aluminium or brass, onto which the metallic plain bearing alloy is disposed in an undetachable fashion, in particular, through sintering, casting or rolling. The invention also comprises plain bearing composite materials with a polymer sliding bearing material which is in most cases impregnated into a porous carrier layer. The plain bearing composite material is formed as a roll and supplied to a production machine, preferably in the form of an endless band. In the production machine, longitudinal sections are separated from the band and “rolled” into the bush shape.

The plain bearing bush 2 has several grooves 8 on its outer periphery 4 that are parallel to each other and concentric with respect to a longitudinal center axis 6 of the plain bearing bush. These are macroscopic grooves with a depth of approximately 0.05 to 0.5 mm. The grooves 8 which are shown as examples in FIG. 2 taper and their flanks 10 extend towards each other at acute angles. The grooves have a V-shaped cross-section. Their flanks 10 form an angle α of 20° to 40°, in particular of 25° to 35°, with respect to an indicated radial plane 12. In the illustrated case, the grooves 8 or their flanks 10 are designed symmetrically with respect to the radial plane 12, which is, however, not absolutely necessary. It is also feasible for the flanks 10 to have different angles of inclination a with respect to the radial plane 12.

When, during calibration of the plain bearing bush 2, a mandrel is guided through the plain bearing bush 2 in the direction of its longitudinal center axis 6, material is deformed causing displacement. Since the outer periphery of the plain bearing bush 2 is fixedly held in the calibration tool, at least part of the displacing deformation will “move” into the grooves 8. The grooves 8 therefore represent an effective reservoir for accepting the material that is displaced due to deformation during calibration. Since the mandrel and the plain bearing bush are moved relative to each other in the axial direction (movement of the mandrel and/or bush relative to each other in the axial direction), the deformation and resulting displacement will mainly act in an axial direction. The grooves 8 are thus narrowed and at least partially closed. In an advantageous fashion, the bush width B can additionally be exactly fixed during calibration by disposing supporting flanks to the front ends 14 of the plain bearing bush 2.

In total, a plain bearing bush can be obtained which is free-falling and can be used without further dimensioning processing.

1-10. (canceled)

11. A rolled plain bearing bush comprising:
a plurality of grooves disposed on an outer side of the rolled plain bearing bush to extend in a circumferential direction, said grooves having a wedge-shaped or V-shaped design and being disposed, structured and dimensioned to at least partially close or narrow in response to acceptance of material displaced during calibration of the plain bearing bush by passing a mandrel through it, while said outer side of the plain bearing bush is held in a containing fashion.

12. The plain bearing bush of claim 11, wherein the grooves are wedge-shaped or V-shaped.

13. The plain bearing bush of claim 11, wherein flanks of said grooves form an angle (α) of 20° to 40° or of 25° to 35° with respect to a radial plane.

14. The plain bearing bush of claim 11, wherein said grooves have a depth of 0.05 to 0.5 mm.

15. The plain bearing bush of claim 11, wherein said grooves have a depth of 5 to 25% of a wall thickness of the bush.

16. The plain bearing bush of claim 11, wherein said grooves have a separation between each other in a longitudinal direction of 1 to 3 mm or 1 to 2 mm.

17. A method for producing and calibrating a rolled plain bearing bush, the method comprising the steps of:
a) separating longitudinal sections from a sheet of material band supplied in a machine direction;
b) introducing, prior to or following step a), grooves on one side of the sheet of material band, the grooves having mutual separations in the machine direction;
c) forming the sheet of material band into a bush shape, wherein the grooves are disposed on an outer side of the bush to extend in a circumferential direction;
d) fixing and holding the outer periphery of the bush; and
e) passing a mandrel through the bush to calibrate the bush, wherein the grooves are partially closed or narrowed due to material deformation.

18. The method of claim 17, wherein the grooves are embossed by rolling a tool.

19. The method of claim 17, wherein the grooves have a wedge-shaped or V-shaped design.

20. The method of claim 17, wherein a bush width is fixed in a tool by supporting flanks during step e).
